(19) United States
(12) Patent Application Publication
(10) Pub. No.: US 2009/0132925 A1
(43) Pub. Date: May 21, 2009

(54) ADVENTURE LEARNING IMMERSION PLATFORM

(75) Inventors: Robert Koehler, Chicago, IL (US); Jeff Fitzpatrick, Lombard, IL (US)

Correspondence Address: MCANDREWS HELD & MALLOY, LTD, 500 WEST MADISON STREET, SUITE 3400, CHICAGO, IL, 60661, US

(73) Assignee: NLI LLC, Chicago, IL (US)

(21) Appl. No.: 11/947,598

(22) Filed: Nov. 29, 2007

Related U.S. Application Data
(60) Provisional application No. 60/988,297, filed on Nov. 15, 2007.

(51) Int. Cl. G06F 3/048

(52) U.S. Cl. 715/730

(57) ABSTRACT

An Adventure Learning venue for a plurality of human participants having a range of binocular has a data communication network. A display is connected to the data communication network, the display being configurable to display a plurality of images around the participants in the participants' range of binocular vision. There is also at least one sound transducer connected to the data communication network, configured to provide sound that appears to be from more than a single direction to each of the participants. The venue has a plurality of participant seats, each participant seat comprising at least one interface control, one seat-based display, and one seat-based interface device, connectable to the data communication network. The venue also has a workstation for a facilitator connectable to the data communication network; the facilitator workstation being configured to exert control over the content provided the display and the sound transducer to the participants. The venue also has a presentation system comprising at least one computer equipped with software to provide content to at least the display and sound transducer.

### CROSS-REFERENCE TO RELATED APPLICATIONS

This application claims the benefit of U.S. Provisional Application No. 60/988,287, filed Nov. 15, 2007.

### BACKGROUND OF THE INVENTION

The present invention is related to multimedia experience systems. In particular, the multimedia experience systems of the present invention addresses the need for multiple people to simultaneously benefit from a learning experience managed with systems configured to enhance the learning experience of the participants.

People learn from experience. One way to direct learning is to preselect experiences for people to learn from, which is the goal of most teaching. In-class teaching provides a directed learning experience, but can be limited by the materials available at a particular location. Traditional in-class teaching is also limited by the fact that the experiences for the students will be limited by what the teacher can provide. A traditional classroom experience does not provide the teacher with the ability to mediate interactive experiences for a multitude of students.

Technology does exist for providing a multitude of students with an experience. However, this technology generally has a single data presentation source, and is often not interactive at all. Examples of technology that conveys a single source of programming to multiple users while not being interactive for them includes film and television. While teachers have access to pre-recorded material for students, they do not have real time access to remote locations to use for teaching. Further, these materials are recorded and presented on 16:9 or 4:3 rectangular screens at a front of a room. It is desirable that real time, interactive, learning experiences be made available for multiple purposes such as enjoyment, training, learning and the like. Advantageously, the participants at a geographic location could interact with each other and users or content at remote geographic locations.

### BRIEF SUMMARY OF THE INVENTION

In one embodiment of the invention, an Adventure Learning platform for a plurality of human participants having peripheral vision can comprise a data communication network. A display is connected to the data communication network, the display comprising one or more display elements, the display being configurable to display a plurality of images from a plurality of content sources extending to fill a 1200 angle from a left of each participant's vision to a right of said participant's vision for a participant facing the center of the image. There is also at least one sound transducer connected to the data communication network, configured to provide sound that appears to be from more than a single direction to each of the participants. Further, a plurality of participant interfaces connectable to the data communication network, each participant interface comprising at least one interface control, and one connection to the data communication network usable by the interface control. There can also be a facilitator workstation connectable to the data communication network, the facilitator workstation being configured to exert control over the content provided the display and the sound transducer to the participants, the facilitator workstation comprising at least one input device, at least one workstation display, and at least one network interface. Also, the platform can include a presentation system comprising at least one computer equipped with software to provide content to at least the display and sound transducer.

In a further embodiment of the invention, the Adventure Learning Platform further comprises a knowledge management system, a video and sound editing system, a document management system, and a learning management system.

In yet another embodiment of the present invention, the Adventure Learning Platform has a display that comprises a front screen, a left screen, and a right screen, each screen being illuminated by a respective front, left and right projector. In a still further embodiment, the plurality of participant interfaces are a plurality of workstations.

In yet another embodiment of the invention, the platforms can have a plurality of participant interfaces that are a plurality of keypads

In another embodiment, the Adventure Learning Platform of claim 1 further comprising a technician workstation configured to exert control over the operation of the display and the sound transducers, the technician workstation comprising at least one input device, at least one workstation display, and at least one network interface.

The present invention also contemplates a method of providing an Adventure Learning experience to an audience where the audience comprises a plurality of participants. The method includes displaying visual content to the plurality of participants, the visual content being displayed extending from a left edge of each participant's peripheral vision to the right edge of said participant's peripheral vision for a participant facing the center of the image. The method also includes playing audio content to the plurality of participants, the audio content appearing to be from more than a single direction to each of the participants. According to the embodiment, each participant is provided with at least one input device and one personal information source, the input device and the information source together being configured to facilitate the participant's interaction with the content or other participants and the promotion of interaction among the participants and the content.

In another aspect of the invention, an Adventure Learning venue is provided for a plurality of human participants having a binocular vision. The venue has a data communication network. A display is connected to the data communication network, comprising one or more display elements, the display being configurable to display a plurality of images around the participants in the vision plane. The venue also has at least one sound transducer connected to the data communication network, configured to provide sound that appears to be from more than a single direction to each of the participants. A plurality of participant seats is provided, each participant seat comprising at least one interface control, one seat-based display, and one seat-based interface device, the seat-based display and the seat-based interface device being connectable to the data communication network. A facilitator workstation connectable to the data communication network is also provided, the facilitator workstation being configured to exert control over the content provided the display and the sound transducer to the participants, the facilitator workstation comprising at least one input device, at least one workstation display, and at least one network interface. Still further, a technician workstation configured to exert control over the operation of the display and the sound transducer, the technician workstation comprising at least one input device, at least one workstation display, and at least one network interface. Also, a presentation system comprising at least one computer equipped with software to provide content to at least the display and sound transducer.

Another aspect of the invention is embodiment when the display further comprises displays above the participants.

A still yet further embodiment of the invention is an Adventure Learning venue where the plurality of participant seats are on a platform, the platform being movable relative to the displays such that the platform can have at least a first position and a second position, so that when the platform moves from a first position to a second position, the display would extend downward farther in the participants' fields of view in the second position than the first position.

Still further benefits and advantages of the invention will be apparent to one skilled in the art from the discussion below. Advantages and benefits are provided for a demonstration of utility, and advantages and benefits not specifically recited in the claims are not intended to limit the invention.

### BRIEF DESCRIPTION OF THE SEVERAL VIEWS OF THE DRAWING(S)

Various examples, objects, features and attendant advantages of the present invention will become fully appreciated as the same becomes better understood when considered in conjunction with the accompanying drawings, in which like reference characters designate the same or similar parts throughout the several views, and wherein:

FIG. 1: is a schematic of an implementation of the invention in a small venue;

FIG. 2: is a schematic of an implementation of the invention in a large venue;

FIG. 3 is an illustration of a layout of screen sections for baseball events; and

FIG. 4 is an illustration of a layout of screen sections for information intensive events.

### DETAILED DESCRIPTION OF THE INVENTION

Although the present invention is susceptible of embodiment in various forms, presently preferred embodiments are shown in the drawings and will hereinafter be described with the understanding that the present disclosure contains exemplifications of the invention and is not intended to limit the invention to the specific embodiments illustrated.

The present invention is embodied in Adventure Learning immersion platform 10. The Adventure Learning immersion platform 10 can be a multi-sensory, interactive, scored and attentive experience beyond distance learning, computer based training (CBT), or television (TV) with enhanced group activity. Aspects of the facility can be set up as theatre sets to allow the creation of a virtual theatre as a fully stage historical reenactment or contemporary virtual copy of an event. For instance, if the subject is historical Shakespeare, then the Globe Theatre might be presented. If a group in Chicago is viewing the Cubs in San Francisco, the facility could be set to recreate AT&T Park. The Adventure Learning immersion platform is a blank canvas on which any event may be simulated. Events may also be designed for police training and medical education/virtual clinic.

The Adventure Learning immersion platform 10 can comprise a venue, venue workstations, participant interfaces, and a plurality of computer systems. It may be implemented to provide active interaction with the participants, or permit the participants to experience the platform passively, or some combination of the two.

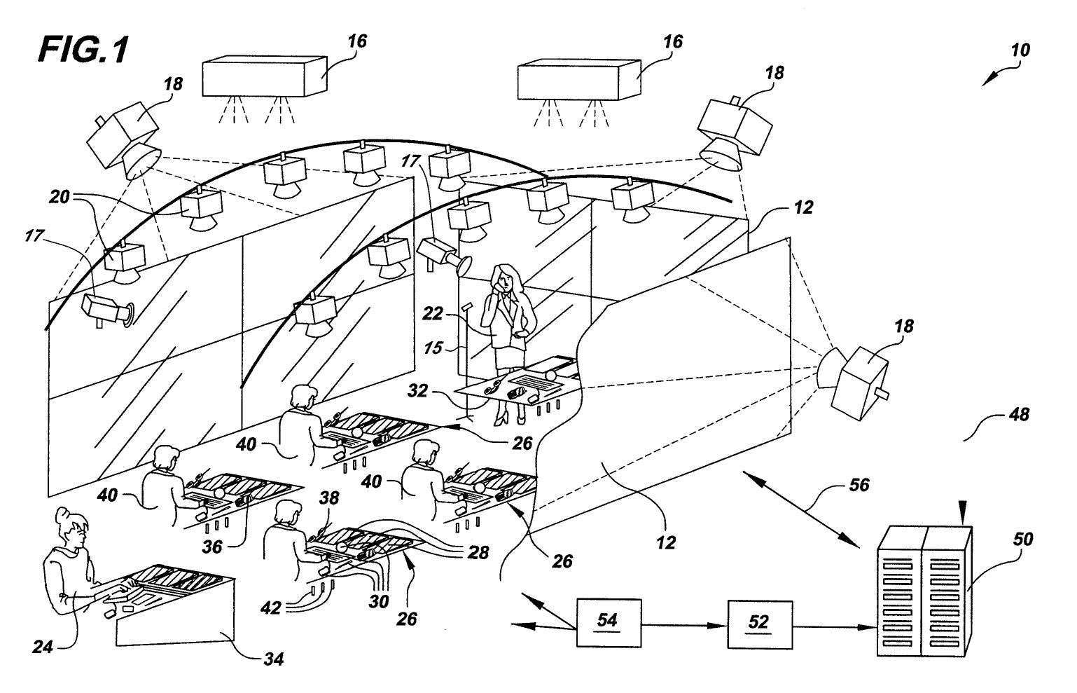

The present invention can be implemented as an interactive experience for a small number of participants 40. Referring to the embodiment of FIG. 1, the platform 10 can be used by at least one facilitator 22, one technician 24, and one participant 40. Exemplarily, the number of participants can be anywhere from 4 to 20 or more. The venue comprises a room with a plurality of displays 12, at least one sound transducer 16; at least one lighting element 20. Those individuals can use at least one participant workstation 26, one facilitator work station 32, and one technician work station 34. The computer systems can comprise a live presentation platform 48, an instruction platform 52 and an administrative platform 54. The displays can be used to view information, information being of any viewable type, including, but not limited to

Displays 12 can be of any type that can display an image large enough present a carefully scaled visual field to the participants 40. The visual field is scaled to provide an immersive experience and is preferably below floor level to over head, from the utmost extension of peripheral vision on the left and right, with display within display windows for dramatic or expository emphasis as created within subject matter specific presentations. With present technology these display types include, but are not limited to: front projection screens, rear projection screens, and even walls themselves (preferably of color to allow the image to be rendered accurately). Also included are (see high end page). The type of screen depends on the application. For purpose-specific installations, the size, surface type and position of displays can be adjusted advantageously for the intended display environment. The equipment effecting the display 12 can comprise one or more display elements, such as a projector and a screen, or a projector and a wall.

Referring to FIG. 1, a projector 18 can project the displayed image onto one of three to six large display 12 screens. The sources of projected images can be any projector 18, preferably a digital projector. Each display 12 screen can have four coordinated display regions imbedded in each, on which the projectors 18 will project respectively. Optionally, there can be even more screens and display regions in a virtual stadium installation to provide IMAX style scale. Examples of the type of content that can be displayed are web pages, computer based training, digital video, statistics and charts, television images and teleconferences. Optionally, a virtual stadium setup can have curved screens. Further, optionally, the platform can include projections on the ceiling.

A display of the present invention can extend to almost fill the binocular vision of a forward-facing person, such as about 120° field of view, or optionally entirely fill the binocular field of vision, such as about 140° field of view. Desirably, the display extends to fill the peripheral vision of a forward-facing person also, or a 180° field of view. Optionally, such a display surrounds a viewing person even further, up to completely, so that a person can turn his head and still have displayed material in the field of vision.

The sound transducers 16 can be sense-around digital sound speakers. The transducers 16 may or may not be accompanied by digital sound processors to optimize the sound for the venue and/or the location of the listeners. Desirably, the speakers are configured to provide maximum quality of sound from voice, instruments or special effects, and are distributed at key points around the venue. The sound transducers 16 can be configured so that sounds can appear to come from multiple directions for each person in the venue.

The venue can be provided with suspended lighting 20. Suspended lighting 20 can keep the atmosphere of the venue suitable for learning and facilitate the sending of participant 40 images. Lighting can be fixed or set on tracks for mobility to best serve diverse applications. In one embodiment, the images can be sent to a remote facility as apart of an interactive exercise.

The facilitator 22 can serve as a Master of Ceremonies in promoting accomplishment of the objectives of the exercise in the venue. The technician 24 is an in class technical support person who operates the venue's equipment that is not controlled by the facilitator 22 or by participants 40. The technician 24 can be located in the room, preferably in the back, or in another room.

Each participant 40 can have a workstation 26. Preferably, the workstation 26 is a workstation 26 tables. Preferably, there is one workstation for each participant 40, and can also be configured for teams of 4 people to facilitate group collaboration.

Content can be provided by discovery teams 46 that can bring mobile content from a remote area. Examples of remote content are artist studio, museum, and archeological site via camcorders, mics, and voice narration; acting suit needs of curriculum and objectives of game learning experience. The discovery teams 44 have a team leader 46.

The participant interfaces can be anything that enables a participant to symmetrically or asymmetrically interact with programming or other users through the Adventure Learning immersion platform 10. A participant interface can be a workstation 26. Each workstation 26 can be configured with one or more of workstation displays 28 for viewing information. Exemplarily, the workstations of FIG. 1 have three local displays imbedded into the workstation 26 table. The workstations 26 can also have interface controls comprising, but not limited to: digital pens and scanning pens (such as made by Wacom, and the Logitech IO Pen, the Sony Ericcson Chat Pen, the Nokia Digital Pen, Oxford Easybook featuring Nokia Digital Pen), a mouse, a trackball, one or more directional microphones (exemplarily, 4), and/or a keyboard. Workstations can also have visual and oral interaction tools such as cameras and microphones to facilitate symmetric and asymmetric interactions between a workstation user and other machines, systems, people, locations and the like. Cameras and microphones can also be provided as part of the venue as well as part of a workstation.

The facilitator 22 can also have a facilitator work station 32. The facilitator work station 32 and controls for the facilitator 2. The facilitator work station 32 is a computer with an interface for technical control of the classroom experience, management and production of the away team, content delivered to the classroom, pushing student desktop content to wall screens for group comment, and communication with the technical support. The facilitator's interface controls can include all interface controls as per the workstations 26 and further comprise classroom or group meeting software such as LiveMeeting or Adobe Connect or Netmeeting. Further communication devices for reaching the technical support or away team for in stream production and trouble shooting may also be available. These include remote control software such as PC Anyware, and Chat and IP based telephone, and walkie talkie, when applicable.

There can be a technician workstation 34 for the technician 24 too. The technician work station 34 with controls for the technician 22 can be located in back of venue.

The participant work station 26, the facilitator work station 32 and the technician work station 34 can each have a telephone 36. The telephone 36 can use any type of telephone service including standard telephone service (POTS), ISDN, FDDI, VOIP or cellular telephone services such as G3, CDMA, AMPS, GSM and TDMA. The workstations 26, 32, 34, can also have a radio communication device 38 such as a walkie talkie, or a combination of a microphone and speakers.

Each workstation 26 32, 34 can have input connections 42 located on side. Preferably these input connections 42 can be for any type of data input, but can exemplarily be USB and multimedia connectors. The workstations 26, 32, and 34 can include both wired (exemplarily USB, IEEE 1394, parallel ports, serial ports) and wireless data connections (exemplarily Bluetooth).

The Adventure Learning immersion platforms 10 of the present invention can use a plurality of computer systems to manage the Adventure Learning experience. The computers comprise a combination of software, hardware and firmware, and is known to those of ordinary skill in the art the implementation of how tasks are carried out by a computer can place particular steps, algorithms or procedures either in software or hardware. Also, each of these systems can use separate or shared hardware to carry out the diverse tasks described. Each is described as a separate system, but the software or hardware may be integrated with that of other tasks as a matter of design preference. The computer systems are to provide knowledge management, content management, video and sound editing, and document management and learning management systems. Software of these types are available on the market, and it is anticipated that they will continue to be available, or even become more available.

A live presentation capture, streaming, and rapid publication systems 48 that can put content online quickly is integral to the servers and local computers. Event content can be either live or produced. Live material cay either simply be experienced, or can be reprocessed for study. In the case of reprocessing, re-processing can be quick and elegant and either done in class or in-between classes by the team that support the facility.

The presentation capture, streaming, and rapid publication systems can be accompanied by a digital editing system 50 for editing sound, graphics, and text has tools to allow participants 40 to create anything the class objectives might call for to prove achievement of objectives. The facilitator 22, when acting in the mode of instructor, may stage material for discussion or interaction using these capabilities. Participants 40 in the mode of trainees may also engage these capabilities as part of enacting a class plan. Accordingly, digital input can be combined from a variety of sources in a manner that supports the participants' 40 efforts in learning or performance.

The digital editing system 50 can in turn interact with an engaged multiplayer game and instruction strategy system 52 design to enable games and learning and performance objectives to be combined most effective manner. Thus, visual and audio content can be brought gracefully into play with verbal or textural content while events are in progress or in fast editing between events. The multiplayer game and instruction strategy permits a synergy of multi-sensory digital artifacts for use in a way that maximizes the impact of the facility.

The instruction strategy system 52 can interact with the digital games integration system 54. The instruction strategy system permits the facilitator 22 to control the use of games or other exercises in learning events and permits the various applications available in the network to be brought to use. The digital games integration system is tied to participant workstations 26 in the venue.

The digital games integration system can also incorporate a Learning Management System (LMS) in order to score participants 40 on exercises and facilitators 22 on administration. The learning management system works by taking the data from games or other exercises which can be either activity or intelligence based. The Learning Management System then can convey the data from the games or other exercises to a database. Examples of data that can be conveyed are: a time to complete a task, a number of correct answers, or a demonstrated ability against a standard model. Examples of using demonstrated ability against a standard model include, but are not limited to using haptics or hand position as modeled by a master tennis player.

The systems detailed can provide sound production to create environmental ambience that surrounds the audience to support recreation of live events and historical re-enactment or dramatic presentations. Sound production systems can also be used to sustain high quality musical performances, and other foreground aural data. Sound production can also be done in with twin layers—such as an ambient or environmental and foreground with parallel in the screen visuals which can be used to create environments and specific points of action/focus upon need as directed by the nature of the event.

The entire set of computer systems can be implemented with a Service-Oriented Architecture (SOA) design 56 to coordinating all of the elements effectively.

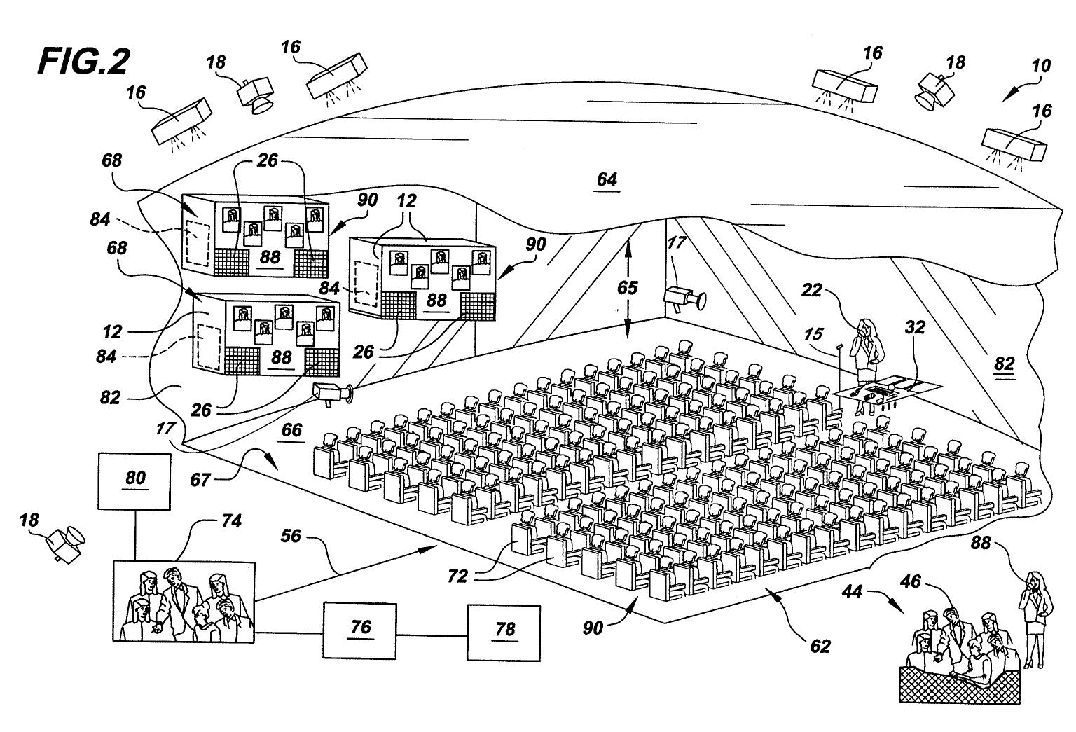

Alternatively, the invention can be implemented to provide an experience for a large number of participants 40, exemplarily 500 or more. Referring to the embodiment of FIG. 2, the large venue can comprise displays 82 and at least one sound transducer 16. Optionally, the venue can comprise a ceiling screen 64. A middle area 65 of the floor and ceiling screen is for peripheral vision displays and partial immersive environment projections. The purpose of the middle area 65 is to allow sights as well as sounds to come from behind, under and over the audience-whether the display in questions is an array of moving planets, a school of fish, a flyball or kicked football. The large venue, like the smaller venue can use screens that are illuminated by projectors 18. The large venue embodiment can also use sound transducers 16 as the smaller venue, but appropriately sized and placed for the larger forum.

The large venue can have a floor level 66 for seats that that is raised relative to the bottoms of the displays 82. This permits the seats 72 (which may be cushioned in style of airline seats, or raw wood in the manner of stadium bleachers, or replaced with couches or easy chairs, depending on the event simulated) to be a distance, exemplarily five feet, to allow for the displays 82 to extend a distance downward from the participant 40 to increase the immersive video experience. The large venue can also have a lower display surface 66 that is below the floor level 66 of the venue and configured to display images as appearing at a depth of about 30 feet. A sunken display area can be used to promote the visceral experience of depth for space or undersea fantasy games of virtual tours that will benefit from that impact. The lower display surface can have a transparent surface, so that it can be used as a walkway, depending on the needs of the simulated environment.

The seats 72 can be fully automated chairs with at least one imbedded display, inputs and/or interfaces. Each seat 72 can be the equivalent of a “front row center” seat, or a “best field seat”, with a degree of “stadium seat” incline. The field seats can be no closer than 30 feet from any wall and they can actually be raised above floor level so that the screens wrap around and under the seating. In the case of a large venue, the participant interfaces can be anything that enables a participant to symmetrically or asymmetrically interact with programming or other users through the Adventure Learning immersion platform 10. A participant interface can be a handheld device, such as a voting device, or can be built into the armrests with functionalities drawn from those available in workstations 26.

In a large venue at least one facilitator 22 and a plurality of participants 40 can use the platform 10. In the embodiment of FIG. 2, there is one facilitator work station 32 for the facilitator 22, but none for the participants 40. The large venue can have control and production facilities 74 having a screen control system 76, an interactive linkage system 78 and a content system 80.

As illustrated by FIG. 2, a platform 10 can optionally have appurtenant venues 88 that are connected to the large venue. The relationship of the appurtenant venues to the main venue is analagous to that of luxury boxes to a stadium. In one application, the appurtenant venues are interactive venues such as those in FIG. 1. Such an application can have the front view of the appurtenant venue 88 be an opening whereby the participants 40 located in the appurtenant venue 88 have the large venue as their front view.

Within appurtenant venues 88 the tables can be optimized for game play and active entertainment participation. The workstations 26 can be configured to be removable from a venue. The appurtenant venues 88 can have seats 68, accommodate as many as 20 people and be a version of the Adventure Learning technical set up without the front screen. The appurtenant venues 88 can have a full view of the large venue as the area is open. The displays 82 extend beyond the open face of the appurtenant venues 88 to the rear wall to entirely surround the appurtenant venues 88 so that the appurtenant venues 88 do not form part of the rear display experienced by the main venue. The appurtenant venues can also have functional side screens 84 located within each appurtenant venue 88. They can have a divided configuration of viewing area. The divided viewing areas can be used exemplarily for showing network feeds, WEB starts sights, sponsored connections to play along or fantasy leagues, view computer games. The functional side screens 84 or their viewing areas can exemplarily 36 have area-to-area live links or across the country links to food ordering, to merchandise purchasing, weather and travel resources. Optionally, the appurtenant venues 88 can have a appurtenant venue display 86 located on the front outside so that when the field seat participants look up and back, they see a projection of the people who are in the actual stadium or theatre that they are ‘viewing’ or ‘participating in’ remotely. The appurtenant venues can also optionally have additional devices go so that virtual golf, surfing, shooting, active digital game play, virtual soccer and other sorts of entertainment and learning activities can be staged without the need for the audience to sit. In the appurtenant venues 88, this involves putting a portable floor on top of stanchions that can be placed between the seats to support it, leaving access to device interfaces.

The large venue can also have control and production facilities 74 that are integrated into the Virtual Stadium or large Digital Communications Center model configuration at the top center of the appurtenant venues 88, and includes the Service-Oriented Architecture (SOA) design 56, the screen control system 76, and interactive linkage system 78. The screen control system 76 controls discreet viewing areas so that the images of grass, sky, crowd etc. can be managed on the displays 82, 64, and 66 in the main venue, as well as any displays in the appurtenant venues 88. The interactive linkage system 78 is for managing content for the participants 40 such as professional for commentary on what is being pictured on the displays. The content system 80 can provide TV, Web, and graphics, and have multiple software configurable viewing areas for TV, WEB content, computer and live feed displays.

The venue can have a data communication network to convey data from one element of the venue to another. The data communications network can be wired, wireless, or a combination of wired and wireless. As a wired network the wires can be of any type, including, but not limited to, any type known in the art including Ethernet, USB, IEEE 1394. Wireless networks can likewise be of any kind known in the art including, but not limited to: wireless LAN, GSM, PCS, D-AMPS, and Wi-Fi.

Referring to FIGS. 1-2, preferably the venue will be provided with a wired network that any displays, screens, projectors, the sound transducers, the workstations, servers, lighting, and other elements that can use data in the venue. This can be done with a network having a 64 bit backbone using appropriate digital switching hardware and fibre optic/T3 connectivity in point to point and many to one and one to many configurations.

The data communication network at a venue can also be connected to a wider area data communication network, such as a WLAN or the Internet so that the venue can be in data communication with other sites, including those that are in closed communication with the venue, or on open networks, such as the Internet.

### EXAMPLE 1

The present invention can be implemented with a portable broadband internet to provide a hybrid reality TV production done under a educational, edutainment, game playing model.

This exemplary implementation is suitable to any industry that trains or provides performance support. It provides access to expertise that is geographically isolated, leverages the best of instructional design, visual and auditory imagery in conventional offerings, and allows for innovation of content production.

This exemplary implementation uses the approach of FIG. 1. Floor to ceiling screens 12 are used to immerse the trainees in media, communication, publication and game interplay in a digital venue. Trainees/students/collaborators use custom podium/tables with imbedded workstations 26 and on-board network, displays, headsets with microphones, digital sketch pads and other devices as required by the experience to meld interpersonal and group dynamics into an interactive communication model. A trained in-class mentor 22 uses the class agenda and state of the art learning facilitation skills to raise class performance to a level of immediate and inspiring experience.

An on site Technical Producer 24 keeps things running smoothly, and an Away Team 44 with top quality digital and sound tools takes the class virtually to any educational or performance site in the world.

Uses include site exploration, collaboration between classrooms, historical virtual tours (museums or historical sites), historical re-enactments, virtual music studio, routine distance learning experiences, game playing, and promotions.

Exemplary project options include: a Fort Dearborn reenactment; an Underground Railway reenactment; A demonstration of plantation life, jazz in Chicago, art in the Renaissance,police and security training, low-end virtual stadium for high school sporting events.

### EXAMPLE 2

Another exemplary implementation of the present invention is a Virtual Stadium created through the use of overlapping displays of cinematic proportions, and smaller displays down to cell phone scale, recreate stadiums, concert venues, present day and historical.

A model stadium can be selected from a menu. For example, Wrigley Field or Soldier Field. The venue can then be configured to the look and feel of the selected venue. Virtual tickets for the participants can be appropriately designed, and visible structures in the background can be appropriately modeled and displayed.

Large screen displays 64, 66, 82 show field, crowd, sky, core action area; smaller displays can key in to dramatic points of view-umpires, locations, specific players or play areas. There can be simulated weather effects.

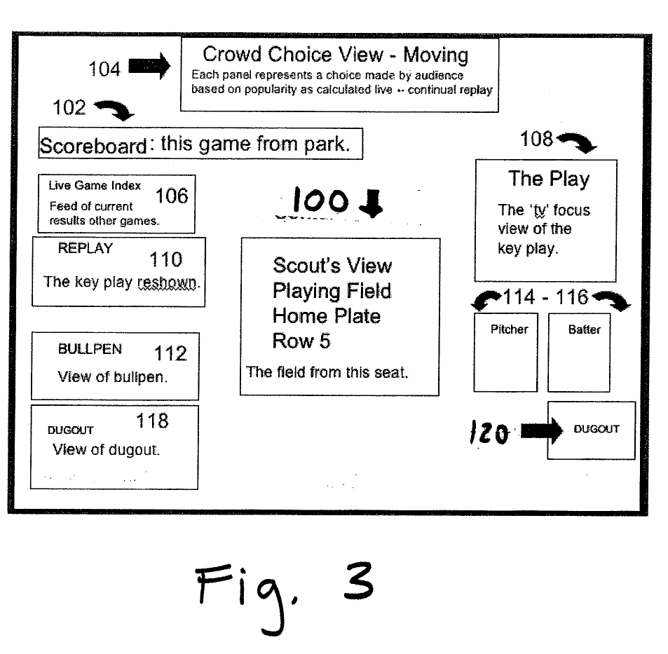

An example forward screen is presented in FIG. 3. The forward screen area depicts a background, such as filled or empty rows of seats from the ballpark facing the center of the screen. It can also have a number of other sub-elements:

100: a fifth row, behind home plate view of the playing field of the event

102: the scoreboard for the event

104: viewers can select or vote for information they would like to see in these displays

106: information about other games or events underway. These can be provided in any way known in the art, such as scrolling across the events or fading from one event to another.

108: the camera that is following the action can show a live-action magnified view of the action, or a view from another angle, such as from an outfield camera

110: replays can be shown here, separately from live action so that replays do not preclude watching the live event

112: the camera watches the bullpen area so that fans can see which pitchers are throwing on the side or warming up

114: a close-up, forward view of the pitcher

116: a close-up, forward view of the batter

118: a view of the third base dugout

120: a view of the first base dugout

The result can be intimate, authentic, exciting, connected. That is the result of removing the alienation of big venues. The virtual stadium is also more cost effective and offers an opportunity to talk with professionals involved in event.

Content display can be managed via user choices that feed into an artificial intelligence system that makes selections based on the preferences of participants. Similarly, the audio production can be participant or facilitator selectable. The virtual stadium can integrate fantasy games to run along with real events. It can also make use of existing feeds and new ‘scout seat/bullpen/dugout/untapped line feeds.’

Exemplary projects that can benefit from this implementation are: baseball, soccer, golf, basketball, football, Negro League Hall of Fame experiences, Major League Baseball Hall of Fame Experiences, or use as a training facility with advanced technology for measuring performance of athletes.

### EXAMPLE 3

The Adventure Learning Platform can be used for virtual baseball scouting. This implementation would use software to display and analyze fielding, throwing, batting, pitching, hitting and running mechanics. Examples could be viewed and comparative measures made. Optionally, annotation tools could be provided, as well as the ability to send, file and reference old and new content.

The software can include a fast report writer with ability for speech to text, speech synthesis, auto-interview, audio journaling, easy send email, paging, calendar, spell check and document management.

The filing can sorting by position, best talent (run, catch, hit, throw), name, team, location, date of filing.

### EXAMPLE 4

The Adventure Learning immersion platform can also be used to create an on-line University.

Three 20×8 foot screens are divided by software into 4 viewing areas. Each viewing area may be combined into unified viewing areas for panoramic displays at varying resolutions. Immersive stereo digital sound can also be provided. There is one high resolution/extreme brightness projector for each screen (total 3), and portable suspended lighting.

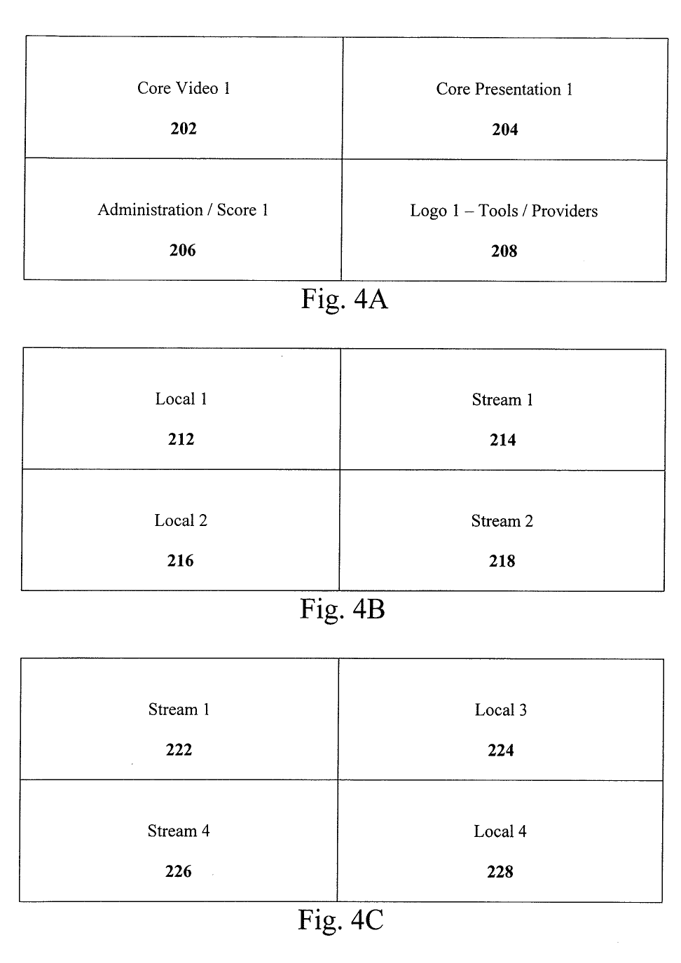

Referring to FIG. 4A, the front screen has regions for Core Video 202, Core Presentation 204, Administration 206, and Tools 208. FIG. 4B shows an exemplary left-screen configuration with Local 1 212, Local 2 214 Stream 1 216, and Stream 2 218. FIG. 4C has an exemplary right screen 220 configuration with Stream 3 222, Stream 4 224, Local 3 226 and Local 4 228.

The role of the stream viewing areas, Stream 1-4, 216, 218, 222, 224 are to display, video, a video game, statistics including Progress Wireframe (a 3D map to show participant location in a simulated environment) and LMS Local (team specific learning management system results—the local site only) and LMS Universal (Learning management results from all sites on the network), internet content, and/or television content. The content in these stream viewing areas can be analog or digital and of a highly diverse nature as demanded by the course of study, the game, the change management subject or other purpose of use. The vital balance of the experience is in the gathering of impressive sounds and images, moving and still, around the subject of shared investigation, training, or enjoyment.

The role of the local viewing areas, Local 1-4, 212, 214, 226, 228 is to display team specific notes for a competitive event, local or team specific LMS (learning management system) content. LMS content and data include, but are not limited to, administrative material, event registration, test or game scores, enrollment, lists of classes in progress, attendance and curricular details. References to local sites refer to the participants in one Adventure Learning platform or virtual stadium site rather than across all such sites and can support a national and/or local chat (voice and text) channel, provide a team-specific away feed, or provide a local game interface.

Core displays can be used for any subject matter that will carry the essential value to be enjoyed, learned or communicated. In the present example Core Video 102 can be used for Away Team Channel transmission and communication to room. The Away Team Channel transmission can provide data coming from a historical site, a rehearsal hall, or a places of importance in contemporary events. On the other hand, Core Presentation can be used for facilitator 22 presentations and other facilitator publications

The Administration display can be used for group, team and/or individual game and learning event score and progress displays, and other LMS (Learning Management System) displays.

The Tools 108 display can be used to display of providers logos, information about tools, or “breaking news” from the provider.

On-line university also has a plurality of servers. A first server can contain a Knowledgebase system, a Language Analysis system, and a Knowledge Links system. The Language Analysis system can comprise one or more functionalities such as speech recognition, speech synthesis, and audio mining. The first server manages data within the classroom around predetermined performance objectives and measures, and link to optional resources outside the classroom. A second server can manage media feeds, the AV library, and video feeds. A third server can maintain databases, such as those provided via SQL, Oracle Cold Fusion, and Microsoft Access. A fourth server has internet server software and data, middleware such as ORB, SDA, RPC, MOM for routine control of calls for data and images from the other servers and for load balancing. The construction of the network regarding specific ‘brand’ choices can be open to allow for evolution and upgrade as technology changes.

The online university can also have a plurality of workstations. A student workstation can comprise a recessed monitor, a keyboard, an imbedded mouse, a headset with a microphone, a digital sketching tool such as a digital pen and tablet, a computer with a CPU, and a DVD burner. The computer in the workstation can further comprise software to control the feeds for local displays, manage chat sessions, capture freehand drawings or computer-aided drawing tools such as Visio, word process, play and capture sound, design and display presentations, publish documents to the web, capture the contents of video screens or compress files for efficiency of storage.

A technician's work station can have a local computer outfitted with a headset with a microphone, universal interface tools, and a DVD Burner player. An exemplary set of software for a technician's work station would be development tools, remote control software for the facility, software to monitor and operate the projectors, a universal screen feed control to route content to various displays, sound processing software, a testing/usage monitor, software to establish links for audio/screen snoop and capture, software for a secure chat channel with the facilitator, and software to monitor the performance of the servers.

The testing and usage monitoring software can be web-based technical trouble shooting software that can determine if software or hardware is viable on a remote basis, without a technician having to visiting individual workstation. The testing and usage monitoring software can be configured to determine what usage level individual workstation software and hardware has been subjected to aid in troubleshooting, to identify license use and presence, and to establish functional value as part of the network's knowledge management function. The monitoring software can also monitor the network to track delivered knowledge value and proactively establish knowledge value added to assist in improving customer experience, positioning components for best use and for use in establishing a valuation of the operating company.

The facilitator version of the workstation can be a computer with a headset, a keyboard, a digital sketching pad, two monitors, and a DVD burner/player. Exemplary software could include chat software (audio and text), digital whiteboard software (including, but not limited to Netmeeting, LIVE Meeting, and Connect), core production tools, a video codec, Learning Management System control (such as SAP's Learning Space), Feed control (a digital interface to manage content on site and select what appears on each screen), software to handle the input from the digital sketch pad, and software for a secure chat channel with the technician.

The field team can be equipped with portable equipment such as digital cameras, video or still, common interface tools (such as a digital dashboard that is a mirror of the classroom facilitator's), sound capture hardware, cellular phones, walkie talkies, a server to synchronize sound to video, a server for data, and a server for internet access and communications. The software available to the field team can include a video editing suite, a sound editing suite, graphics creation or modification software, audio or text chatting software, audio and video snooping and capturing software, and database software. Preferably, the field team would have broadband communications access, whether wired or wireless.

1. An Adventure Learning platform for a plurality of human participants having peripheral vision comprising:
a data communication network;
a display connected to the data communication network, the display comprising one or more display elements, the display being configurable to display a plurality of images from a plurality of content sources extending to fill a 120° angle from a left of each participant's vision to a right of said participant's vision for a participant facing the center of the image;
at least one sound transducer connected to the data communication network, configured to provide sound that appears to be from more than a single direction to each of the participants;
a plurality of participant interfaces connectable to the data communication network, each participant interface comprising at least one interface control, and one connection to the data communication network usable by the interface control;
a facilitator workstation connectable to the data communication network, the facilitator workstation being configured to exert control over the content provided the display and the sound transducer to the participants, the facilitator workstation comprising at least one input device, at least one workstation display, and at least one network interface; and
a presentation system comprising at least one computer equipped with software to provide content to at least the display and sound transducer.

2. The platform of claim 1, wherein the Adventure Learning platform further comprises:
a knowledge management system;
a video and sound editing system;
a document management system; and
a learning management system.

3. The Adventure Learning platform of claim 1, wherein the display comprises a front screen, a left screen, and a right screen, each screen being illuminated by a respective front, left and right projector.

4. The platform of claim 1, wherein the plurality of participant interfaces are a plurality of workstations.

5. The platform of claim 1, wherein the plurality of participant interfaces are a plurality of keypads

6. The Adventure Learning platform of claim 1 further comprising a technician workstation configured to exert control over the operation of the display and the sound transducers, the technician workstation comprising at least one input device, at least one workstation display, and at least one network interface.

7. A method of providing an Adventure Learning experience to an audience, the audience comprising a plurality of participants, comprising:
displaying visual content to the plurality of participants, the visual content being displayed extending from a left edge of each participant's peripheral vision to the right edge of said participant's peripheral vision for a participant facing the center of the image;
playing audio content to the plurality of participants, the audio content appearing to be from more than a single direction to each of the participants;
providing each participant with at least one input device and one personal information source, the input device and the information source together being configured to facilitate the participant's interaction with the content or other participants; and
promoting interaction among the participants and the content.

8. An Adventure Learning venue for a plurality of human participants having a vision plane comprising:
a data communication network;
a display connected to the data communication network, comprising one or more display elements, the display being configurable to display a plurality of images around the participants in the vision plane;
at least one sound transducer connected to the data communication network, configured to provide sound that appears to be from more than a single direction to each of the participants;
a plurality of participant seats, each participant seat comprising at least one interface control, one seat-based display, and one seat-based interface device, the seat-based display and the seat-based interface device being connectable to the data communication network;
a facilitator workstation connectable to the data communication network, the facilitator workstation being configured to exert control over the content provided the display and the sound transducer to the participants, the facilitator workstation comprising at least one input device, at least one workstation display, and at least one network interface;
a technician workstation configured to exert control over the operation of the display and the sound transducer, the technician workstation comprising at least one input device, at least one workstation display, and at least one network interface; and
a presentation system comprising at least one computer equipped with software to provide content to at least the display and sound transducer.

9. The Adventure Learning venue of claim 8, wherein the display further comprises displays above the participants.

10. The Adventure Learning venue of claim 8, wherein the plurality of participant seats are on a platform, the platform being movable relative to the displays such that the platform can have at least a first position and a second position, so that when the platform moves from a first position to a second position, the display would extend downward farther in the participants' fields of view in the second position than the first position.
